(19) United States
(12) Patent Application Publication
(10) Pub. No.: US 2011/0253836 A1
(43) Pub. Date: Oct. 20, 2011

(54) AIRCRAFT BIN MODULE WITH INTEGRATED AIR DUCTS AND LIGHTING

(75) Inventor: Frank E. HASHBERGER, Snohomish, WA (US)

(73) Assignee: BE INTELLECTUAL PROPERTY, INC., Wellington, FL (US)

(21) Appl. No.: 13/089,114

(22) Filed: Apr. 18, 2011

Related U.S. Application Data
(60) Provisional application No. 61/326,145, filed on Apr. 20, 2010.

(51) Int. Cl. B64D 11/00; B64D 13/00

(52) U.S. Cl. 244/118.5

(57) ABSTRACT

An aircraft overhead luggage bin module includes a stowage bin assembly, an integral light assembly providing structural stiffness to an upper portion of the stowage bin assembly. The stowage bin assembly includes an air distribution plenum that also transmits loads to mounting structures, an upper air diffuser connected to the air distribution plenum, and an optional lower sidewall diffuser connected to the air distribution plenum.

### CROSS-REFERENCES TO RELATED APPLICATIONS

This application is based upon and claims priority from Provisional Patent Application No. 61/326,145, filed Apr. 20, 2010, which is incorporated by reference in its entirety herein.

### BACKGROUND OF THE INVENTION

The present invention relates generally to overhead luggage bins for aircraft, and more particularly relates to an aircraft overhead luggage bin module with integrated air ducts and lighting compatible with existing air duct support structures and electrical lighting support structures, and suitable for retrofitting of aircraft with overhead stowage bins having reduced weight and increased structural capability.

Overhead luggage bins have traditionally been designed as a single purpose component for temporary storage of luggage, with other functional components, such as air conditioning ducting components and lighting components secured to the overhead luggage bins by secondary, additional mounting brackets that, when considered together for an entire aircraft, can contribute significant undesirable weight to the overall weight of the aircraft.

It would be desirable to provide an aircraft bin module with air duct and lighting components integrated therein, and that can be connected to existing aircraft structures to reduce the weight of such overhead luggage bin, air duct and lighting components, so as to contribute to overall aircraft weight reduction by elimination of secondary brackets to hold the lighting and air distribution components, and to reduce installation time for retrofitting such overhead stowage bins in an aircraft.

It would also be desirable to provide an aircraft bin module with air duct and lighting components integrated therein that can be retrofitted to and connected to existing aircraft luggage bin, air ducting and lighting support structures to provide increased structural capability of the stowage bin system, by integrating the lighting and air distributing component features into the stowage bin structure. The present invention meets these and other needs.

### SUMMARY OF THE INVENTION

Briefly, and in general terms, the present invention provides for an aircraft overhead luggage bin module that includes integrated air duct and lighting components so as to contribute to aircraft weight reduction, to provide increased structural capability of the stowage bin system by integrally bonding the lighting and air distribution components into the stowage bin structure, and to reduce installation time for retrofitting such overhead stowage bins in an aircraft.

Accordingly, the present invention provides for an overhead luggage bin module for aircraft having an existing air duct structure to conduct cabin air flow, an existing support structure for an overhead luggage bin, and a main cabin area. The overhead luggage bin module includes a stowage bin assembly, and an integral light assembly integrally bonded to an upper portion of the stowage bin assembly and configured to provide structural stiffness to the upper portion of the stowage bin assembly. An air distribution plenum is integrally bonded to the stowage bin assembly, and is configured to receive and distribute the cabin air flow from the existing air duct structure. An upper air diffuser is also integrally bonded to the stowage bin assembly, and is connected to receive the cabin air flow from the air distribution plenum and distribute air to the main cabin.

In a presently preferred aspect, the air distribution plenum includes a triangular torque box configured to transmit loads from the stowage bin assembly to the existing aircraft structure. In a presently preferred aspect, the air distribution plenum includes an air inlet configured to be connected to the existing air duct structure of the aircraft to receive the cabin air flow. In another presently preferred aspect, a lower sidewall diffuser is integrally bonded to the air distribution plenum and is configured to distribute a portion of the cabin air flow along an aircraft sidewall. In another presently preferred aspect, the integral light assembly provides a mounting surface for bin door hinges.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a top perspective view of an aircraft bin module according to the present invention.

### DETAILED DESCRIPTION OF THE PREFERRED EMBODIMENTS

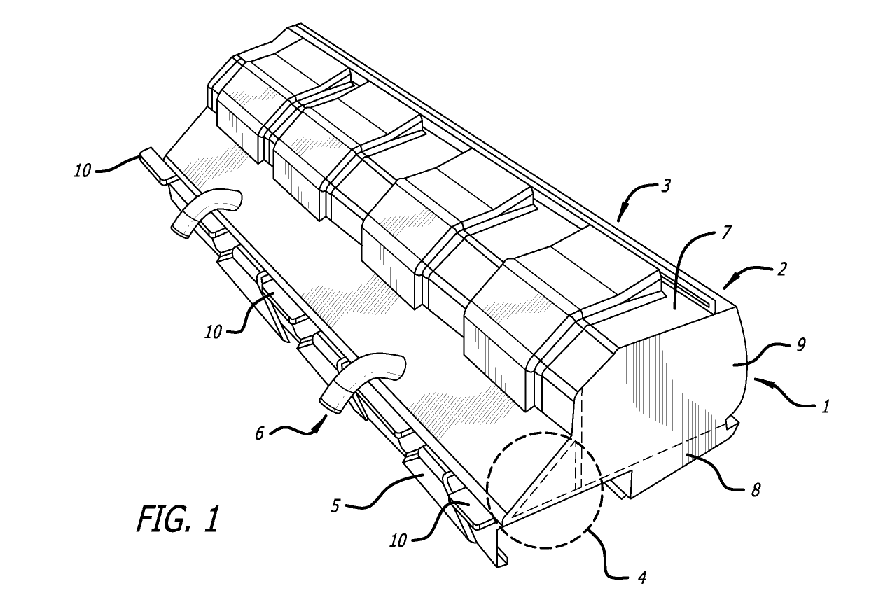

Referring to FIG. 1, which is provided by way of example, and not by way of limitation, the present invention provides for an aircraft overhead luggage bin module for an aircraft having an existing air duct structure, an existing support structure for an overhead luggage bin, and a main cabin area. The aircraft overhead luggage bin module includes an integrally bonded stowage bin assembly 1 having an upper portion 7, a lower portion 8 for supporting luggage stowed in the luggage bin module, and side walls 9 bonded to the upper and lower portions. An integral light assembly and structural reinforcement member 2 is integrally bonded to a front portion of the upper portion of the stowage bin assembly, and provides structural stiffness to the upper portion of the stowage bin. The integral light assembly and structural reinforcement member also provides a mounting surface for bin door hinges for mounting of luggage compartment doors to the front of the stowage bin assembly. An upper air diffuser 3 is preferably integrally bonded to the upper portion of the stowage bin assembly, and distributes cabin air flow to the main cabin. The upper air diffuser is connected to and receives the cabin air from an air chamber or air distribution plenum 4, which is a part of the bonded structure of the stowage bin assembly. The air chamber or air distribution plenum includes one or more air inlets 6 that are configured to be connected to the aircraft's existing main ducting.

Mounting attachments 10 for mounting the stowage bin assembly to the existing aircraft structure are integrally bonded to a rear side of the air chamber or air distribution plenum of the stowage bin assembly. The air chamber or air distribution plenum preferably forms a triangular torque box configured to transmit loads from the stowage bins and their contents to the mounting attachments and to the aircraft structure. A lower sidewall diffuser 5 is also preferably integrally bonded to the rear side of the air chamber or air distribution plenum of the stowage bin assembly, and distributes a portion of the cabin air along the aircraft sidewall.

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. An overhead luggage bin module for an aircraft having an existing air duct structure to conduct cabin air flow, an existing support structure for an overhead luggage bin, and a main cabin area, comprising:
a stowage bin assembly having an upper portion, a lower portion, and sidewalls;
an integral light assembly integrally bonded to said upper portion of said stowage bin assembly, said integral light assembly being configured to provide structural stiffness to the upper portion of the stowage bin assembly;
an air distribution plenum integrally bonded to said stowage bin assembly, said air distribution plenum being configured to receive and distribute the cabin air flow from the existing air duct structure; and
an upper air diffuser integrally bonded to said stowage bin assembly, said upper air diffuser being connected to receive the cabin air flow from said air distribution plenum, and said upper air diffuser being configured to distribute air to the main cabin.

2. The overhead luggage bin module of claim 1, wherein said integral light assembly provides a mounting surface for bin door hinges.

3. The overhead luggage bin module of claim 1, wherein said air distribution plenum includes an air inlet configured to be connected to the existing air duct structure of the aircraft to receive the cabin air flow.

4. The overhead luggage bin module of claim 1, wherein said air distribution plenum comprises a triangular torque box configured to transmit loads from the stowage bin assembly to the existing aircraft structure.

5. The overhead luggage bin module of claim 1, further comprising a lower sidewall diffuser integrally bonded to said air distribution plenum, said lower sidewall diffuser being configured to distribute a portion of the cabin air flow along an aircraft sidewall.

6. An overhead luggage bin module for an aircraft having an existing air duct structure to conduct cabin air flow, an existing support structure for an overhead luggage bin, and a main cabin area, comprising:
a stowage bin assembly having an upper portion, a lower portion, and sidewalls; and
an integral light assembly integrally bonded to said upper portion of said stowage bin assembly, said integral light assembly being configured to provide structural stiffness to the upper portion of the stowage bin assembly.

7. The overhead luggage bin module of claim 6, further comprising an air distribution plenum integrally bonded to said stowage bin assembly, said air distribution plenum being configured to receive and distribute the cabin air flow from the existing air duct structure.

8. The overhead luggage bin module of claim 7, further comprising an upper air diffuser integrally bonded to said stowage bin assembly, said upper air diffuser being connected to receive the cabin air flow from said air distribution plenum, and said upper air diffuser being configured to distribute air to the main cabin.

9. The overhead luggage bin module of claim 6, wherein said integral light assembly provides a mounting surface for bin door hinges.

10. The overhead luggage bin module of claim 7, wherein said air distribution plenum includes an air inlet configured to be connected to the existing air duct structure of the aircraft to receive the cabin air flow.

11. The overhead luggage bin module of claim 7, wherein said air distribution plenum comprises a triangular torque box configured to transmit loads from the stowage bin assembly to the existing aircraft structure.

12. The overhead luggage bin module of claim 7, further comprising a lower sidewall diffuser integrally bonded to said air distribution plenum, said lower sidewall diffuser being configured to distribute a portion of the cabin air flow along an aircraft sidewall.

13. An overhead luggage bin module for an aircraft having an existing air duct structure to conduct cabin air flow, an existing support structure for an overhead luggage bin, and a main cabin area, comprising:
a stowage bin assembly having an upper portion, a lower portion, and sidewalls;
an integral light assembly integrally bonded to said upper portion of said stowage bin assembly, said integral light assembly being configured to provide structural stiffness to the upper portion of the stowage bin assembly; and
an air distribution plenum integrally bonded to said stowage bin assembly, said air distribution plenum being configured to receive and distribute the cabin air flow from the existing air duct structure.

14. The overhead luggage bin module of claim 13, wherein said integral light assembly provides a mounting surface for bin door hinges.

15. The overhead luggage bin module of claim 13, wherein said air distribution plenum includes an air inlet configured to be connected to the existing air duct structure of the aircraft to receive the cabin air flow.

16. The overhead luggage bin module of claim 13, wherein said air distribution plenum comprises a triangular torque box configured to transmit loads from the stowage bin assembly to the existing aircraft structure.

17. The overhead luggage bin module of claim 13, further comprising a lower sidewall diffuser integrally bonded to said air distribution plenum, said lower sidewall diffuser being configured to distribute a portion of the cabin air flow along an aircraft sidewall.

18. The overhead luggage bin module of claim 15, further comprising an upper air diffuser integrally bonded to said stowage bin assembly, said upper air diffuser being connected to receive the cabin air flow from said air distribution plenum, and said upper air diffuser being configured to distribute air to the main cabin.

19. The overhead luggage bin module of claim 16, further comprising an upper air diffuser integrally bonded to said stowage bin assembly, said upper air diffuser being connected to receive the cabin air flow from said air distribution plenum, and said upper air diffuser being configured to distribute air to the main cabin.

20. The overhead luggage bin module of claim 17, further comprising an upper air diffuser integrally bonded to said stowage bin assembly, said upper air diffuser being connected to receive the cabin air flow from said air distribution plenum, and said upper air diffuser being configured to distribute air to the main cabin.
